(19) United States
(12) Patent Application Publication
(10) Pub. No.: US 2014/0272571 A1
(43) Pub. Date: Sep. 18, 2014

(54) Electroactive Polymer Coating for Improved Battery Safety

(71) Applicant: PHYSICAL SCIENCES, INC., (US)

(72) Inventor: Christopher M. Lang, Haverhill, MA (US)

(21) Appl. No.: 13/835,572

(22) Filed: Mar. 15, 2013

(51) Int. Cl. H01M 4/66; H01M 4/84; H01M 4/82

(52) U.S. Cl. CPC H01M 4/668; H01M 4/82; H01M 4/84
USPC 429/215; 427/122; 427/123; 427/58; 427/600

(57) ABSTRACT

A single or multi-component polymer coating is applied to components used in fabrication of electrochemical cells to protect the cells from damages that can result in cell imbalance or cell performance reduction. The polymer coating is electrically conductive under normal operating conditions but, when operated at low voltages, functions as an insulative material that increases the electrical resistance of the cell components. This increased electrical resistance improves cell safety by minimizing short-circuit current flow and reducing heating rate in the cell components.

### GOVERNMENT SUPPORT

The subject matter described herein was supported in part by the United States Air Force contract numbers FA8650-10-M-2054 and FA8650-11-C-2142 and the National Aeronautics and Space Administration (NASA) contract number NNX10CD32P. The U.S. Government may have certain rights.

### FIELD OF THE INVENTION

The invention generally relates to providing protection against potential damage in electrochemical cells, such as lithium-ion cells. In particular, the invention relates to providing normal or improved electrical and ion transport to components of an electrochemical cell, while, for example, insulating the components from damaging situations, such as short-circuit or excessive discharge. Insulation of electrochemical cell components can result in increased electrical resistance of these components, can cause reduction of current flow in the components during over-discharge conditions, and can minimize the potential for catastrophic cell failure.

### BACKGROUND

The capacity of lithium-ion cells can decrease during cycling due to unwanted reactions that occur because of over-discharge conditions. To date, various options for monitoring and protecting individual and packs of lithium-ion cells from situations that can cause cell capacity reduction (e.g., over-discharge, short-circuit, etc.) have been identified. For example, many available battery systems incorporate hardware switches and/or control algorithms in their external circuitry that prevent the system from entering situations that can result in capacity reduction. However, due to, for example, the differences in operating single cells and packs of cells, such external control circuits can be expensive to implement since the external control circuits need to be specifically designed and optimized for the individual battery packs (or cells) that they are intended to protect. Also, given that such control circuits are non-active components of the circuit, they can result in a reduction of the overall energy density of the battery system.

When operating in battery packs, a single protection circuit may not be able to sufficiently protect all of the individual cells in the battery from being substantially discharged. For example, when operating a battery pack including four cells, each delivering between 3.0 and 4.1 Volts of voltage, the minimum voltage that can be obtained from the battery pack is 12 Volts (i.e., four battery cells each operating at 3.0 V). However, when fully charged, this voltage can be obtained by, for example, operating three of the four cells at full capacity and/or with the voltage of the fourth cell set at zero. In such a situation, the fourth cell can be excessively charged, resulting in, for example, a decreased life cycle of the overall battery pack. Therefore, individual monitoring and control of each cell in a battery pack can be required to track or monitor overcharge or discharge conditions. However, as noted, such monitoring of individual cells can be costly and ineffective. Further, even if individualized protection circuits are utilized, these systems typically serve to warn an operator and/or prevent continued current flow to the battery. They typically cannot stop or impede the discharge process.

### SUMMARY

A conductive additive for an electrochemical cell electrode that includes a carbon additive material and an electroactive polymer coating dispersed on the carbon additive material is featured in some embodiments disclosed herein. The electroactive polymer functions as an insulating layer when a potential in the electrochemical cell is less than a switching voltage. The electroactive polymer functions as a conductive layer when the potential in the electrochemical cell is greater than the switching voltage.

The electroactive polymer can be selected from a family of polymers that can reversibly oxidize and reduce and switch between a conductor and an insulator. Such polymers are described in United States Patent Application Publication No. 2009/0176160, filed on Jun. 5, 2008, which is incorporated herein by reference in its entirety. The electroactive polymer can be a structural member that provides an open channel for ionic transport.

Certain embodiments feature a conductive additive for an electrochemical cell electrode. The conductive additive includes a non-conductive material and an electroactive polymer coating dispersed on the non-conductive material. The electroactive polymer functions as an insulating layer when the potential in the electrochemical cell is less than a switching voltage and functions as a conductive layer when the potential in the electrochemical cell is greater than the switching voltage.

Some embodiments feature a method of forming an electroactive polymer coated material. The method involves dissolving an electroactive polymer in a solvent to form a mixture, adding at least one of an oxide, metal or carbon-based material to the mixture to form a slurry, and drying the slurry to form the electroactive polymer coated material.

Certain embodiments, feature a method of forming an electroactive polymer coated conductive additive. The method involves providing a conductive additive and coating the conductive additive with an electroactive polymer layer. The electroactive polymer layer functions as an insulating layer when a potential in an electrochemical cell is less than a switching voltage. The electroactive polymer layer functions as a conductive layer when the potential in the electrochemical cell is greater than the switching voltage.

In other examples, any of the aspects above, or any apparatus or method described herein, can include one or more of the following features.

In some embodiments, the switching voltage can be approximately 3 volts. In some embodiments, the switching voltage can be approximately 3.0 to 3.6 volts. In some embodiments, a lithium metal reference electrode can be used to measure the switching voltage. In certain embodiments, the electroactive polymer can include at least one of poly(3-hexythiophene), poly alkylthiphene, poly(ethylene oxide), polyacrylonitrile, polydimethylsiloxane, polystyrene, poly(methyl methacrylate), poly(2,6-dimethyl-1,4-phenylene oxide), and polyvinylpyrrolidone, or a combination thereof.

In some embodiments, the carbon additive material is at least one of acetylene black, carbon black, carbon nanofibers, carbon nanotubes, graphene, graphite, or a combination thereof. The carbon additive material can be conductive and/or have a particle size of less than 25 microns.

In certain embodiments, the non-conductive material can have a particle size of less than 25 microns. The non-conductive material can include at least one of fumed silica, silica particles, silica fiber, or silicon particles.

In some embodiments, the method for forming an electroactive polymer coated carbon additive adds at least two of the oxide, metal or carbon-based material to the mixture to form the slurry. In certain embodiments, the method for forming an electroactive polymer coated carbon additive can add at least one of the oxide, metal or carbon-based material to the mixture to form the slurry and add another of the oxide, metal or carbon-based material to the slurry. In some embodiments, the slurry can be sonicated.

In certain embodiments, the slurry can be dried by evaporating the slurry using an evaporation cup, casting the slurry on a glass dish, spraying or atomizing the slurry, adding the slurry to a non-solvent and precipitating the electroactive polymer on at least one of the oxide, metal or carbon-based material, or combination thereof. The slurry can be added drop-wise to the non-solvent.

In some embodiments, a secondary solvent can be added to the mixture. The amount of the secondary solvent can be selected so that the electroactive polymer does not precipitate from the mixture.

In certain embodiments, the method for forming an electroactive polymer coated carbon additive can use a solvent including at least one of chloroform, dichlorobenzene, chlorobenzene, trichloromethan, tetrahydrofuran, xylene, or poly(3-alkylthiophenes).

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic of an electrochemical cell circuit, according to an illustrative embodiment of the invention.

FIG. 2 is a flow diagram of the various methods for applying an electroactive polymer coating to components of an electrochemical cell, according to embodiments of the invention.

FIG. 3 is an exemplary graphical illustration of the oxidation and reduction of the electroactive polymer coating.

FIG. 4 is an exemplary graphical illustration of the performance of electrodes with and without the electroactive polymer coating on voltage scans between 0.6 and 4.3V.

FIG. 5 is an exemplary graphical illustration of the high rate discharge performance of electrodes with and without the electroactive polymer coating.

FIG. 6 is an exemplary graphical illustration of the charging performance of electrodes with and without the electroactive polymer coating after high rate overdischarge to 0.6V.

FIG. 7 is an exemplary graphical illustration of the impedance performance of pouch cells constructed with and without the electroactive polymer coatings.

FIG. 8 is an exemplary graphical representation of the charge/discharge performance of pouch cells constructed with and without the electroactive polymer coatings disclosed herein.

FIG. 9A and FIG. 9B illustrate the performances of a control pouch cell and a pouch cell having a coated cell component, according to an embodiment of the invention.

FIG. 10 illustrates exemplary graphical results obtained from testing of an electrochemical cell in presence and absence of polymer coatings.

FIG. 11 is an exemplary illustration of charge and discharge cycles for an electrochemical cell having various levels of electroactive polymer applied to its cell components.

### DETAILED DESCRIPTION

Some embodiments disclosed herein address electrochemical cell problems, for example, cell short-circuit, substantial discharge, and other catastrophic cell failures, by, for example, application of a single or multi-component polymer coating to certain components of the electrochemical cell. Such components can include conductive additives, electrode materials, and/or current collectors utilized in the fabrication of the electrochemical cells. The polymer coating can function to protect electrode materials from damages that can result in cell imbalance and/or cell performance reduction.

The polymer coating can be electrically conductive under normal operating conditions but, when operated at low voltages, functions as an insulative material that increases the electrical resistance of the cell components. This increased electrical resistance improves cell safety by minimizing short-circuit current flow and reducing heating rate in the cell components (e.g., the cathode electrode of the cell). Further, once applied to the cell components, the coating provides protection at interfaces of these components and allows for in situ protection of the component materials.

FIG. 1 is a schematic of an electrochemical cell circuit (e.g., a battery or a lithium ion battery) 100, according to an illustrative embodiment of the invention. The electrochemical cell circuit 100 includes an external circuit 170 that derives electrical energy, through conduction of electrons 105, from an electrochemical cell 101. The electrochemical cell 101 includes anode 110 and cathode 140 electrodes. The electrodes 110, 140 can include electrochemically active materials, conductors, and binders. The electrochemically active materials can include conductive additives 120. In some embodiments, the conductive additive material 120 is at least one of acetylene black, carbon black, carbon nano-fibers, carbon nanotubes, grapheme, graphite, or a combination thereof.

During operation, the conductive additive 120 can conduct electrons from the current collector to the active materials to permit operation of the cell. Its inclusion can ensure sufficient electrical conductivity so as to minimize voltage loss across the active electrode.

The conductive additive can include a variety of materials, herein collectively referred to as additive materials 125. In some embodiments, the additive material 125 can be a conductive material, such as a conductive carbon additive (not shown). In some embodiments, the carbon additive material can have a particle size of less than 25 microns. In certain embodiments, the additive material can be a non-conductive material.

The conductive additive 125 is coupled with an electroactive polymer coating 160 that is electrically conductive under normal operating conditions but, when operated at low voltages, functions as an insulative material that increases the electrical resistance of the cell components. The electroactive polymer 160, as noted above, can function to protect the conductive additive and other battery components (e.g., battery components to which the conductive additive is coupled) against conditions that can damage the electrochemical cell.

The anode 110 can include graphite, lithium titanate, tin, siliconparticles or combinations thereof. Commercially available plate-like graphite/carbon particles, e.g., graphite particles available from Superior Graphite, CPREME or similar companies, can be used. The cathode 140 can include cathode particulates 180 that can include metal oxide or metal phosphate particles. In some embodiments, the cathode particulates can be coupled with an electroactive polymer coating 160. In some embodiments, the electrochemical cell 101 can include anode particulates (e.g., anode 104) and cathode particulates (e.g., cathode 140) spaced from the anode particulates. A separator 130 can be situated between the anode and cathode electrodes 110, 140.

The electrodes 110, 140 and separator 130 can be in contact with a liquid electrolyte solution (not shown). The liquid electrolyte solution can facilitate ion transfer between the electrodes 110, 140. In some embodiments, one or more current collectors (generally shown as current collector 150 coupled with the cathode 140) can be coupled to each of the electrodes 110, 140.

Low capacity cells positioned in a series configuration in a battery can be overcharged, despite starting with a balanced battery pack. Also, overcharging of a battery can attack cells, cause corrosion of current collectors, attack electrolytes, cause electrode delamination, degrade performance, decrease cycle life, increase internal impedance, and/or cause reduction of the amount of power produced by the battery.

In order to protect the electrochemical cell 101 from catastrophic cell failures, such as cell short-circuit and substantial discharge, an electroactive polymer 160 can be coupled with at least one cell component, such as electrodes 140, the current collector 150, or the conductive additive 120 of the electrochemical cell 101. The cell components can be made using any material that can be coupled with a suitable electroactive polymer 160 that has a switching voltage greater than the charge voltage of that material. For example, a cathode made using lithium cobalt oxide or lithium nickel cobalt manganese oxide based materials can be used with a poly(3-hexythiophene)-regioregular electroactive polymer.

The polymer 160 can switch between being an insulator and a conductor based on the voltage of the electrochemical cell. For example, the polymer 160 can serve as an insulator when a potential and/or switching voltage in the electrochemical cell 101 is less than a predetermined switching voltage. The polymer can serve as a conductor when the potential in the electrochemical cell 101 is greater than the predetermined switching voltage. The predetermined switching voltage can be the voltage at which damaging cell conditions are expected to occur. In some embodiments, the predetermined switching voltage is approximately 3.0 V. In some embodiments, the predetermined switching voltage is between about 3.0 to 3.6 volts.

The polymer 160 can be applied to the cell components in a number of ways. In some embodiments, the polymer 160 is applied by dissolving the desired polymers, such as P3BT and PEO, in a solvent, such as chloroform. Once dissolved, the desired amount of the component, such as acetylene black, to be coated is added to the solution. The coated material is then produced by evaporating off the solvent using one of a number of techniques. For example, the solvent may be evaporated off while shearing the mixture. Similarly, the mixture may be spray dried to remove the solvent and produce the desired coated material. In some embodiments, the application method used to applying the polymer 160 can depend on factors such as the component type (e.g., conductive additive 120, cathode 140, current collector 150, etc.), the component material type (e.g., aluminum metal for a cathode current), polymer type, etc.

In some embodiments, cathode materials 140, current collectors 150, and/or conductive additives 120 can be coated with the electroactive polymer 160. In certain embodiments, the electroactive polymer 160 is integrated with the cell components (e.g., conductive additive 120, cathode 140, or current collector 160 materials). For example, as shown in FIG. 1, the polymer 160 can be coated on a carbon additive 125 included in the conductive additive 120 and/or be integrated into the carbon additive 125 that forms the conductive additive 120. Regardless of which component(s) (e.g., 120, 140, and/or 160) the electroactive polymer 160 is coupled to, each element coupled to the electroactive polymer can switch between functioning as a conductor when operated at voltages higher than a predetermined switching voltage, and as an insulator when operated at voltages lower than the switching voltage.

The chemistry of the electroactive polymer 160 can be selected to ensure that it maintains oxidized and conductive during normal battery operations while reversibly switching from a conductor to an insulator if operated at voltages below the predetermined switching voltage. The switching voltage can correspond to an oxidation potential of the electroactive polymer. When the voltage drops, the polymer can be reduced and the electrical conductivity can be reduced. In certain embodiments, the switching voltage of the polymer 160 is about 3.0 V. In some embodiments, the switching voltage of the polymer 160 is about 3.0 V to about 3.6 V.

In some embodiments, the electroactive polymer 160 includes commercially available poly(3-hexythiophene) (P3HT). In certain embodiments, the electroactive polymer 150 includes at least one of poly(3-hexythiophene), poly alkylthiphene, poly(ethylene oxide), polyacrylonitrile, polydimethylsiloxane, polystyrene, poly(methyl methacrylate), poly(2,6-dimethyl-1,4-phenylene oxide), and polyvinylpyrrolidone, or a combination thereof. An electrochemical cell 101 having the electroactive polymer 160 (e.g., P3HT as the electroactive polymer) integrated into at least one of its components (e.g., cathode material, current collector, or conductive additive) can provide enhanced over-discharge protection while retaining state of the art battery performance.

In certain embodiments, the electroactive polymers 160 can be applied to the surfaces of the cell components in a number of ways. Specifically, the method used for applying the coating to the surfaces can vary depending on the application and the type of cell components. For example, in some embodiments, the electroactive polymers 160 can be applied to the surfaces of the cell components in the form of a coating applied to the cell components' surfaces.

FIG. 2 is a flow diagram of exemplary procedures for applying an electroactive polymer (e.g., electroactive polymer 160 as described above in FIG. 1) to components of an electrochemical cell, according to an illustrative embodiment of the present invention. The methods shown in FIG. 2 can be used to coat one or more of the cell components. In some embodiments, not all of the illustrated procedures are used when coating a single component.

As illustrated in FIG. 2, the coating can be applied by first dissolving the electroactive polymer component in solvent(s) 210. If forming a composite polymer coating, additional polymers can be added and dissolved. For example, in certain embodiments, electroactive polymer poly(3-Hexylthiophene) (P3HT) can be used along with a solvent that can dissolve the electroactive polymer. Examples of such solvent include, but are not limited to, chloroform, chlorobenzene, dichlorobenzene, and/or Tetrahydrofuran (THF).

In certain embodiments, the amount of polymer added to the solvent may be monitored and controlled to ensure enhanced performance of the polymer coating. For example, in one embodiment, when utilizing poly(ethylene oxide) (PEO) for the electroactive polymer, the appropriate amount of PEO is selected to ensure that the solution included about 1% weight per volume total polymer. In some embodiments, 0.016 g (grams) of P3HT, 0.004 g of PEO, 1.5 ml (milliliters) of chloroform, and 0.05 ml of N-Methyl-2-pyrrolidone (NMP) can be employed. In certain embodiments, 0.03 g of P3HT, 2.85 ml of chloroform, and 0.15 ml of NMP can be employed.

In certain embodiments, the mixture obtained from mixing the electroactive polymer in the solvent can be processed to enhance its performance 320. For example, the mixture can be processed in a dry box including up to 10% N-methyl-2-pyrrolidone (NMP) to improve particle wetting and enhance its performance.

A slurry is formed 230 by adding an additive material, for example, an oxide, metal or carbon-based material, to the mixture formed by dissolving the electroactive polymer in the solvent. In certain embodiments, a high speed mixer can be used to form the slurry. A cell component is added to the slurry 240, mixed, and sonicated to form a homogeneous slurry. The sonication can act to untangle the particles of the additive material and orient the P3HT chains. The number and duration of sonication and mixing procedures can be configured, customized, and optimized, depending on application, for each system.

Collection of the coated powder on the cell components' surface can be carried out, in a number of ways and can depend on the application at hand. For example, in some embodiments, the slurry can be further mixed, for example in a mixer, while being dried, on the cell components' surface, using a specially designed evaporation cup 250. This cup can allow the solvent (e.g., chloroform) to evaporate while spinning the sample (i.e., cell components) in the mixer. In some embodiments, the mixer can be a shear mixer. The shear mixer (e.g., operating at 3450 RPM) can ensure uniform distribution of the polymer during drying.

In some embodiments, blended polymer coatings can be formed by dissolving a polymer in the non-solvent used to precipitate the coating. The resulting powder or coated aluminum is dried under vacuum. In some embodiments, regardless of how the coating is applied, the final product of the coating process can include coated cell components, for example, coated aluminum foil current collectors, cathode materials, and/or conductive carbon, that can be utilized in place of the uncoated material(s) in the electrochemical cell.

In certain embodiments, an aluminum current collector can be coated by first dissolving P3HT at 0.5% or 1% in a mixture of chloroform and dichlorobenzene. The introduction of dichlorobenzene can reduce the evaporation rate, and/or improve the consistency of the cast films. Solutions can be prepared with chloroform, chlorobenzene, dichlorobenzene, or tetrahydrofuran (THF) alone or as mixtures of two or more of the solvents. In some embodiments, a volume ratio of 1:20 of dichlorobenzene to chloroform can be used to provide consistent films for coating the cell components with 0.5% samples providing protection but minimizing the impact on discharge capacity. Solutions can be prepared and cast in ambient air. In certain embodiments, improved quality can be obtained by processing in an Argon glove box with controlled moisture/oxygen content. Once the film is cast on the component surface, it is allowed to completely dry 290, for example overnight prior to use. In some embodiments, electrodes can be cast directly on the coated aluminum foil with no changes to the process.

In certain embodiments, the slurry can be cast out on in a glass dish and rapidly dried 360 and subsequently applied to the cell components. In certain embodiments, For example, electroactive polymer component can be cast on certain aluminum foil current collectors using a blade, such as a doctor's blade. In some embodiments, cathode and/or conductive additives can be coated by adding the desired material(s) to the polymer solution to form a slurry. After mixing, the coated particles can be recovered by either rapidly drying the slurry or adding the slurry in a drop-wise fashion to a non-solvent to precipitate the coating on the surface.

In some embodiments, the slurry can be added drop-wise to a non-solvent under constant agitation precipitating the coating on the particle surfaces 270. In some embodiments, additional polymers, that are insoluble in the solvent, can be incorporated to dissolve the electroactive polymer. For example, in one embodiment, PAN coatings can be prepared by adding P3HT and PAN components to a non-solvent, such as DMF, and precipitating P3HT and PAN components on the cell components (e.g., cathode materials). The resulting powder can be collected and rapidly dried by thinly casting on a glass dish.

The coated powders, once applied to the cell components' surface, are dried 290. In some embodiments, the coated powders can be dried in a vacuum or inert atmosphere. In some embodiments, the powders are dried for a predetermined minimum amount of time (e.g., 12 hours, overnight, etc.). In some embodiments, the coated powders can be readily substituted for the uncoated materials in the preparation of the cell components (e.g., cathode electrodes).

In order to evaluate the performance of a coated cell component, cyclic voltammetry (CV) scans can be utilized to compare the electrochemical properties of the uncoated and coated electrodes. FIG. 3 is an exemplary graphical illustration of the performance of an electrochemical cell component in presence of an electroactive polymer coating. In this example, the presence and performance of coatings are evaluated using a number of electrochemical tests. The cell components (e.g., cathode material) are prepared with up to 60% P3HT and coated with acetylene black (AB) and a binder. Half-cells are prepared versus lithium metal using the pre-weighed cathodes and once prepared, the impedance of the half-cells is measured. Further, cyclic voltammetry (CV) scans are performed. The scans are started by starting the operation of the cell at about 1 mV/s, from an open circuit voltage (OCV), to 4.0 V and back to OGV.

The portion of this scan that is conducted between 3.2 V and 3.8 V is shown in FIG. 3. On the forward scan (i.e., while increasing the voltage from 3.2 V to 3.8 V), an oxidation peak 310 is observed at around 3.4V vs. Li⁺/Li (e.g., when measured using a lithium metal reference electrode). This peak 310 is typically not observed on testing of an uncoated cathode. The oxidation voltage corresponds closely to the oxidation voltage measured on testing P3HT coated aluminum in a similar manner. Further, on increasing from 4% to 6% P3HT, the current due to P3HT oxidation can be seen to increase due to, for example, the increased loading. Once the scan reaches 4.0 V, the scan direction is reversed to determine the reversibility of the P3HT coating. On scan reversal (i.e., while decreasing the voltage from 3.8 V to 3.2 V), a reduction peak 320 can be observed. The reduction peak 320 is centered at about 3.3 V, or just negative of that for the oxidation. The peak 310 at 3.4V on the forward scan is assigned to the oxidation of the P3HT, or the point at which the electroactive polymer, P3HT, is “switched on” to function as a conductor. The peak 320 at 3.3V, on the return scan, is assigned to the reduction of the P3HT, or the point at which the electroactive polymer, P3HT, is “switching off” from functioning as a conductor and begins functioning as an insulator.

FIG. 4 is an exemplary graphical illustration of the performance of an electrochemical cell component in absence of an electroactive polymer coating. The results presented in FIG. 4 demonstrate the CV scans conducted while varying the voltage from OCV to 4.3V, on the forward scan, reversing the scan back to 0.6V, on the reverse scan, and finally returning to OCV.

As shown in FIG. 4, for the control cell components, on scanning from OCV to 4.3V, one large peak 410 is observed corresponding to the oxidation (lithium removal) of the LiCoO₂ cathode. On scan reversal, a corresponding reduction occurs as the lithium returns to the cathode structure, however, beyond 3.5 V the reversible reaction is complete and little current is passed until −1.3 V. At voltages below 1.3 V, reduction of the electrolyte occurs as with the formation of a solid electrolyte interface (SEI) on the anode of a lithium ion cell. Additionally, some reduction of the cathode is believed to occur, as on the reversal scan, two oxidation peaks 420, 430 are present, at approximately 2.2V and 3V. These can be attributed to reduction of the cathode as SEI formation is generally reported to be an irreversible process.

The results for an electrode formed on coating both the AB and cathode with a P3HT-PEO mixture are also shown in FIG. 4. For this electrode, the lithium removal trace shows no polarization tracking the control cell until the highest currents are reached. At these higher removal rates, the lithium diffusion through the P3HT may dominate. If this is the case, greater PEO content may improve the rate performance. However, as indicated by the similar re-lithiation peak current, the coating permits similar lithium removal to those in the control case. If the removal is less, the peak current will be reduced. On examining the remainder of the scan, the current at 0.6V is less than one-third of that for the control case. Further, on reversal scan, the multitude of peaks observed previously is almost completely muted. This implies the remaining reactions are nearly entirely irreversible and that the coating acts to isolate the cathode material from excess reduction. These reactions can occur between the electrolyte and aluminum current collector and/or test fixture assembly, in which case building pouch or cylindrical cells with double sided electrodes can substantially reduce the current transfer and can further improve the performance of a cathode after a short or over-discharge situation.

FIG. 5 is a graphical illustration of performance of an exemplary electrochemical cell component coated with an electroactive polymer. Specifically, performance of the coated AB/cathode system on 10C discharge to 0.6V is shown (where “C” denotes the rate at which 100% of the cell capacity is recovered in 1 hour). As illustrated, at low voltages, the coating becomes insulative and results in minimizing the reactions occurring in the electrochemical cell. In contrast, the control (uncoated) electrode remains conductive at low voltages, resulting in reduction of cathode material and electrolytes employed in the electrochemical cell. Numerically stated, over the normal discharge range (4.2 V to 2.0 V), the coated cathode delivers 128.8 mAh/g of capacity 510. This is in comparison to the 124.5 mAh/g of capacity 520 demonstrated in the control cell. Further, when operating at 2.0 V, the P3HT-PEO coating of the coated cell components reduces the charge pass by 98% through increasing the electrical resistance and minimizing the reactions that can occur.

FIG. 6 is a graphical illustration of comparison of performances offered by an electrochemical cell component in coated and uncoated states. As shown in FIG. 6, following a 10C discharge, on a subsequent 1C charge, the coated cell immediately bounces back to the normal charge/discharge range, resulting in no additional charge pass to resume cycling. In contrast the control cell only reaches the 3.5 V point after more than 125 mAh/g of charge pass (relative to the mass of the active component) or nearly the nominal capacity of the cathode. In total, 322 mAh/g of charge is supplied before the uncoated cell concludes the charging procedure. These results demonstrate that the coating insulates the cathode material and protects the cathode from excess reduction, thereby enabling the cell to continue cycling normally after being over-discharged.

FIG. 7 is a graphical representation of the performance obtained from a pouch cell using an embodiment disclosed herein. Such pouch cells can offer standalone cell architecture of sufficient size to minimize the variation that can occur upon testing milligram quantities of materials as in a coin cell. FIG. 7 illustrates impedance tests performed to illustrate the increased resistance of the coatings in their switched off-state (i.e., when operating as insulators). As shown, in the control uncoated cell, the cathode and anode are observed with a total resistance of approximately 1Ω. In contrast for the coated cell, the resistance of the cathode dominates, resulting in more than five times the resistance offered by the uncoated cell. A similar trend is observed when examining the capacitance, as the coating results in a more capacitive and insulative electrode. This increased resistance is additively combined with the additional resistances of the system, thereby reducing the flow of current through the cell at a given voltage. To ensure normal cell operation, the increased resistance, demonstrated in FIG. 8, is reversible. This is because, in absence of a reversible resistance, polarization can occur, resulting in the failure of normal charge and discharge in the cell.

FIG. 8 is a graphical illustration of first charge and discharge for the pouch cell shown in FIG. 7. On the charging steps, the voltage for the coated cell can be seen to be slightly higher than that for the uncoated cell for the majority of the step. However, near the conclusion of the test, the slopes change and the coated cell charges longer. This can be an indication of improved electrical conductivity and access to the cathode material. An increase in electrical conductivity is supported by the higher discharge voltage for the cell with coatings, while the increased discharge time supports increased interaction with the cathode material. These results demonstrate that the coating is capable of switching from its insulative state to a conductor which permits normal charge/discharge cell cycling.

FIG. 9A and FIG. 9B illustrate the performances of a control pouch cell and a pouch cell having a coated cell component, according to an embodiment disclosed herein. The pouch cell testing demonstrates the performance of the coatings on short circuit conditions. Pouch cells of 75 to 475 mAh are constructed with and without polymer coatings. Short-circuit is simulated by rapidly discharging the cells through resistors of 0.5Ω or less. For example, the 470 mAh cells, shown in FIGS. 9A and 9B, were discharged through a 0.1Ω load. As the pouch cells are all constructed with roughly the same surface area, utilization of larger cells results in greater available energy per square centimeter, allowing for measurement of the temperature response of the cell. However, since voltage and current are linearly related (i.e., V=IR, where V denotes voltage, I denotes current, and R denotes resistance), when Vₘₐₓ=4.2 V, the maximum current achievable using a 0.1Ω load is I=42 A, or a 90C-rate for a 470 mAh cell. In practice, the effective voltage (and thus current) is lower and the utilization of lower resistance loads is limited by the resistance of wires and connections, which become increasingly more significant. In contrast, utilization of smaller 75 mAh cells results in increasing the maximum potential C-rate to greater than 550.

FIG. 10 illustrates the graphical results obtained from testing of an electrochemical cell in presence and absence of polymer coatings. Specifically, a cell having approximately 75 mAh is considered and tested with and without polymer coatings. As shown, the coating of the current collector and AB/cathode material reduces the initial current on load application by 70% from 18.8 A/g-cathode for the uncoated cell to 5.5 A/g-cathode for the coated cell. Testing of various pouch cell sizes demonstrates that the polymer coating significantly reduces the peak current and corresponding heat generation on short-circuit. On internal shorting, the polymer coatings functions to minimize localized heating that may reduce the lifetime of cells or lead to catastrophic cell failure.

FIG. 11 is an illustration of charge and discharge cycles for an electrochemical cell having various levels of electroactive polymer applied to its cell components. As shown in FIG. 11, the application of the coating to the aluminum current collector reduces the capacity by approximately 1.5%. However, on applying the polymer coating to both the AB/cathode and current collector, the performance improves slightly (by 1%). Upon examining the voltage traces for all three systems, no significant polarization is observed, highlighting that the coatings remain conductive in the normal charge/discharge range.

While the invention has been particularly shown and described with reference to specific illustrative embodiments, it should be understood that various changes in form and detail may be made without departing from the spirit and scope of the invention.

What is claimed is:

1. A conductive additive for an electrochemical cell electrode comprising:
a carbon additive material; and
an electroactive polymer coating dispersed on the carbon additive material, the electroactive polymer functioning as an insulating layer when a potential in the electrochemical cell is less than a switching voltage and functioning as a conductive layer when the potential in the electrochemical cell is greater than the switching voltage.

2. The conductive additive of claim 1 wherein the switching voltage is approximately 3.4 volts.

3. The conductive additive of claim 1 wherein the switching voltage is approximately 3.0 to 3.6 volts.

4. The conductive additive of claim 1 wherein the electroactive polymer includes at least one of poly(3-hexythiophene), poly alkylthiphene, poly(ethylene oxide), polyacrylonitrile, polydimethylsiloxane, polystyrene, poly(methyl methacrylate), poly(2,6-dimethyl-1,4-phenylene oxide), and polyvinylpyrrolidone, or a combination thereof.

5. The conductive additive of claim 1 wherein the carbon additive material is at least one of acetylene black, carbon black, carbon nanofibers, carbon nanotubes, grapheme, graphite, or a combination thereof.

6. The conductive additive of claim 1 wherein the carbon additive material has a particle size of less than 25 microns.

7. The conductive additive of claim 1 wherein the carbon additive material is conductive.

8. A conductive additive for an electrochemical cell electrode comprising:
a non-conductive material; and
an electroactive polymer coating dispersed on the non-conductive material, the electroactive polymer functioning as an insulating layer when the potential in the electrochemical cell is less than a switching voltage and functioning as a conductive layer when the potential in the electrochemical cell is greater than the switching voltage.

9. The conductive additive of claim 8 wherein the switching voltage is approximately 3.4 volts.

10. The conductive additive of claim 8 wherein the switching voltage is approximately 3.0 to 3.6 volts.

11. The conductive additive of claim 8 wherein the electroactive polymer includes at least one of poly(3-hexythiophene), poly alkylthiphene, poly(ethylene oxide), polyacrylonitrile, polydimethylsiloxane, polystyrene, poly(methyl methacrylate), poly(2,6-dimethyl-1,4-phenylene oxide), and polyvinylpyrrolidone, or a combination thereof.

12. The conductive additive of claim 8 wherein the non-conductive material has a particle size of less than 25 microns.

13. The conductive additive of claim 8 wherein the non-conductive material comprises at least one of fumed silica, silica particles, silica fiber, or silicon particles.

14. A method of forming an electroactive polymer coated material comprising:
dissolving an electroactive polymer in a solvent to form a mixture;
adding at least one of an oxide, metal or carbon-based material to the mixture to form a slurry; and
drying the slurry to form the electroactive polymer coated material.

15. The method of claim 14 wherein at least two of the oxide, metal or carbon-based material are added to the mixture to form the slurry.

16. The method of claim 14 wherein adding at least one of the oxide, metal or carbon-based material includes adding at least one of the oxide, metal or carbon-based material to the mixture to form the slurry and adding another of the oxide, metal or carbon-based material to the slurry.

17. The method of claim 14 further comprising sonicating the slurry.

18. The method of claim 14 wherein drying the slurry includes evaporating the slurry using an evaporation cup.

19. The method of claim 14 wherein drying the slurry includes casting the slurry on a glass dish.

20. The method of claim 14 wherein drying the slurry includes spraying or atomizing the slurry.

21. The method of claim 14 wherein drying the slurry includes adding the slurry to a non-solvent and precipitating the electroactive polymer on at least one of the oxide, metal or carbon-based material.

22. The method of claim 21 wherein the slurry is added dropwise to the nonsolvent.

23. The method of claim 14 further comprising adding a secondary solvent to the mixture, wherein an amount of the secondary solvent is selected so that the electroactive polymer does not precipitate from the mixture.

24. The method of claim 14 wherein the electroactive polymer comprises includes at least one of poly(3-hexythiophene), poly alkylthiphene, poly(ethylene oxide), polyacrylonitrile, polydimethylsiloxane, polystyrene, poly(methyl methacrylate), poly(2,6-dimethyl-1,4-phenylene oxide), and polyvinylpyrrolidone, or a combination thereof.

25. The method of claim 14 wherein the solvent comprises at least one of chloroform, dichlorobenzene, chlorobenzene, trichloromethan, tetrahydrofuran, xylene, or poly(3-alkylthiophenes).

26. A method of forming an electroactive polymer coated conductive additive comprising:
providing a conductive additive; and
coating the conductive additive with an electroactive polymer layer, wherein the electroactive polymer layer functions as an insulating layer when a potential in an electrochemical cell is less than a switching voltage and the electroactive polymer layer functions as a conductive layer when the potential in the electrochemical cell is greater than the switching voltage.
